(19) United States
(12) Patent Application Publication
(10) Pub. No.: US 2012/0127628 A1
(43) Pub. Date: May 24, 2012

(54) CERAMIC COMPOSITION FOR MULTILAYER CERAMIC CAPACITOR, MULTILAYER CERAMIC CAPACITOR COMPRISING THE SAME AND METHOD OF MANUFACTURING MULTILAYER CERAMIC CAPACITOR

(75) Inventors: Eun Jung LEE, Suwon (KR); Hang Kyu Cho, Yongin (KR); Su Yeoun Kim, Suwon (KR); Byeong Gyu Park, Suwon (KR); Doo Young Kim, Yongin (KR)

(73) Assignee: SAMSUNG ELECTRO-MECHANICS CO., LTD.

(21) Appl. No.: 13/160,167

(22) Filed: Jun. 14, 2011

(30) Foreign Application Priority Data
Nov. 24, 2010 (KR) 10-2010-0117765

(51) Int. Cl. H01G 4/12; H01G 7/00; C04B 35/47; C04B 35/01; C04B 35/468

(52) U.S. Cl. 361/321.4; 501/151; 501/137; 501/136; 29/25.41

(57) ABSTRACT

There are provided a ceramic composition for a multilayer ceramic capacitor, a multilayer ceramic capacitor comprising the same, and a method of manufacturing the multilayer ceramic capacitor. The ceramic composition includes a dielectric ceramic powder; an organic binder; and an antistatic agent represented by a specific Chemical Formula. A ceramic green sheet comprising the ceramic composition according to an exemplary embodiment of the present invention only generates a small amount of static electricity and shows excellent mechanical physical properties even in the case that the thickness thereof is thin.

### CROSS-REFERENCE TO RELATED APPLICATIONS

This application claims the priority of Korean Patent Application No. 10-2010-0117765 filed on Nov. 24, 2010, in the Korean Intellectual Property Office, the disclosure of which is incorporated herein by reference.

### BACKGROUND OF THE INVENTION

1. Field of the Invention

The present invention relates to a ceramic composition for a multilayer ceramic capacitor, a multilayer ceramic capacitor comprising the same, and a method of manufacturing the multilayer ceramic capacitor, and more particularly, to a ceramic composition for a multilayer ceramic capacitor having excellent separation properties and a simple stacking process, a multilayer ceramic capacitor comprising the same, and a method of manufacturing the multilayer ceramic capacitor.

2. Description of the Related Art

Generally, electronic components using ceramic materials, such as a capacitor, an inductor, a piezoelectric element, a varistor, a thermistor, or the like, include a ceramic body, internal electrodes formed in the ceramic body, and external electrodes mounted on surfaces of the ceramic body to be connected to the internal electrodes.

Among the ceramic electronic components, a multilayer ceramic capacitor includes a plurality of dielectric layers, internal electrodes disposed to face each other, in which each pair of internal electrodes has one of the dielectric layers disposed therebetween, external electrodes electrically connected to the internal electrodes.

The multilayer ceramic capacitor has been extensively used as a component for mobile communication devices, such as computers, PDAs, mobile phones and the like, due to the advantages of miniaturization, high capacity, ease of mounting, and the like.

Recently, as the electronic products have become small and multi-functional, chip components have also tended to become small and multi-functional. Following this trend, a demand for a small-sized and high-capacity multilayer ceramic capacitor has been increased.

As for a general method of manufacturing a multilayer ceramic capacitor, ceramic green sheets are manufactured and a conductive paste is printed on the ceramic green sheets to thereby form inner electrode layers. Tens to hundreds of such ceramic green sheets, provided with the internal electrode layers, are then laminated to thereby create a green ceramic laminate. Thereafter, the green ceramic laminate is compressed at high temperature and high pressure and subsequently cut into green chips. Thereafter, the individual green chips are subjected to plasticizing, firing, and polishing processes, and external electrodes are then formed thereupon, thereby completing a multilayer ceramic capacitor.

Recently, attempts to make the ceramic green sheets thin and multi-layered have been conducted in order to implement a small-sized and large-capacity multilayer ceramic capacitor. As the ceramic green sheet is thinner, the content of a binder included in the ceramic green sheets are increased in order to exhibit mechanical physical properties. As the content of the binder is increased, various side effects are caused due to static electricity generated on the ceramic green sheets. Due to the generation of static electricity, the ceramic green sheets, when stacked, may be folded, may not be properly separated, and may adsorb foreign objects. Accordingly, the quality of the multilayer ceramic capacitor may be deteriorated.

### SUMMARY OF THE INVENTION

An aspect of the present invention provides a ceramic composition for a multilayer ceramic capacitor having excellent separation properties and a simple stacking process, a multilayer ceramic capacitor comprising the same, and a method of manufacturing the multilayer ceramic capacitor.

According to an aspect of the present invention, there is provided a ceramic composition for a multilayer ceramic capacitor, the ceramic composition comprising: a dielectric ceramic powder; an organic binder; and an antistatic agent represented by the following Chemical Formula:

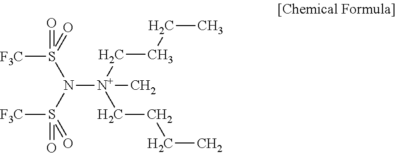

The content of the antistatic agent may be 0.1 to 10 parts by weight per 100 parts by weight of the dielectric ceramic powder.

The dielectric ceramic powder may be a barium titanate-based material or a strontium titanate-based material.

The content of the organic binder may be 5 to 20 parts by weight per 100 parts by weight of the dielectric ceramic powder.

According to another aspect of the present invention, there is provided a multilayer ceramic capacitor comprising: a ceramic body having a plurality of dielectric layers stacked therein, the dielectric layers comprising a ceramic composition comprising a dielectric ceramic powder, an organic binder, and an antistatic agent; internal electrodes formed within the ceramic body; and external electrodes formed on an outer surface of the ceramic body and electrically connected to the internal electrodes, wherein the antistatic agent is represented by the following Chemical Formula:

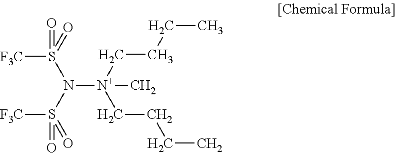

The content of the antistatic agent may be 0.1 to 10 parts by weight per 100 parts by weight of the dielectric ceramic powder.

The content of the organic binder may be 5 to 20 parts by weight per 100 parts by weight of the dielectric ceramic powder.

The ceramic body may further include an adhesive layer formed between the plurality of dielectric layers.

The adhesive layer may include an organic binder having a degree of polymerization higher than that of the organic binder of the ceramic composition.

Each of the dielectric layer may have a thickness of 10 μm or less.

The dielectric layers may include 100 or more dielectric layers.

According to another aspect of the present invention, there is provided a method of manufacturing a multilayer ceramic capacitor, the method comprising: preparing a plurality of ceramic green sheets with a ceramic composition comprising a dielectric ceramic powder, an organic binder, and an antistatic agent; forming internal electrode patterns on the ceramic green sheets; and forming a ceramic laminate by stacking the ceramic green sheets in a thickness direction thereof, wherein the antistatic agent is represented by the following Chemical Formula:

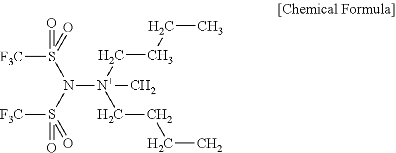

The forming of the ceramic laminate may be performed by adsorbing the ceramic green sheets onto a laminator, moving the ceramic green sheets, detaching the ceramic green sheets from the laminator, and stacking the ceramic green sheets in the thickness direction thereof.

The ceramic green sheets may be separated from carrier films and be adsorbed onto the laminator.

The method may further include forming adhesive layers on the ceramic green sheets after the internal electrode patterns are formed on the ceramic green sheets.

The adhesive layers may include an organic binder having a degree of polymerization higher than that of the organic binder of the ceramic composition.

The content of the antistatic agent may be 0.1 to 10 parts by weight per 100 parts by weight of the dielectric ceramic powder.

The content of the organic binder may be 5 to 20 parts by weight per 100 parts by weight of the dielectric ceramic powder.

Each of the ceramic green sheets may have a thickness of 10 μm or less.

The ceramic green sheets may include 100 or more ceramic green sheets.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view showing a multilayer ceramic capacitor according to an exemplary embodiment of the present invention;

FIG. 2 is a cross-sectional view taken along line A-A′ of FIG. 1;

FIG. 3 is a cross-sectional view explaining a method of manufacturing a multilayer ceramic capacitor according to an exemplary embodiment of the present invention; and

FIG. 4 is a graph showing the amount of static electricity generated over time, on a ceramic green sheet according to an inventive example and a ceramic green sheet according to a comparative example.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

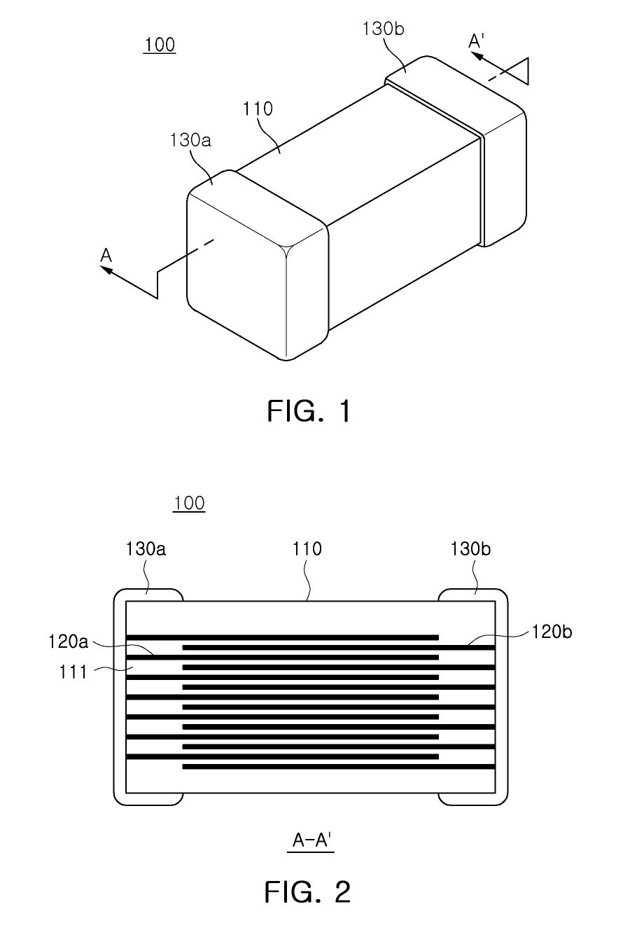

FIG. 1 is a schematic perspective view showing a multilayer ceramic capacitor according to an exemplary embodiment of the present invention; and FIG. 2 is a cross-sectional view taken along line A-A′ of FIG. 1.

A multilayer ceramic capacitor 100 according to an exemplary embodiment of the present invention includes a ceramic body 110 in which a plurality of dielectric layers are stacked, internal electrodes 120a and 120b formed on the dielectric layer, and external electrodes 130a and 130b formed on an outer surface of the ceramic body 110 and electrically connected with the internal electrodes 120a and 120b.

The ceramic body 110 has the plurality of dielectric layers 111 stacked therein, and the adjacent dielectric layers being sintered may be integrally formed to the extent that a boundary may not be apparent.

The dielectric layers 111 may include a ceramic composition according to an exemplary embodiment of the present invention. The detailed description thereof will be described below.

The internal electrodes 120a and 120b are formed to have one dielectric layer disposed therebetween by a sintering process during the stacking process of the plurality of dielectric layers within the ceramic body.

The internal electrodes 120a and 120b may be at least one pair of first and second internal electrodes 120a and 120b having different polarities. The pair of internal electrodes may be disposed to face each other in the stacking direction of the dielectric layers. Ends of the first and second internal electrodes 120a and 120b may be alternately exposed at both ends of the ceramic body.

The first and second internal electrodes 120a and 120b may be made of a conductive metal, but the invention is not limited thereto. For example, the first and second internal electrodes 120a and 120b may be made of Ni or a Ni alloy. The Ni alloy may contain Mn, Cr, Co, or Al, together with Ni. The average particle size of the conductive metal may be 0.1 μm to 0.5 μm. The thickness of the internal electrode may be 0.5 μm to 1.5 μm.

Each end of the first and second internal electrodes 120a and 120b exposed at the ends of the ceramic body 110 is electrically connected to the first and second external electrodes 130a and 130b formed on the outer surface of the ceramic body, respectively.

The ceramic dielectric layers 111 of the multilayer ceramic capacitor according to the exemplary embodiment of the present invention may include a ceramic composition according to an exemplary embodiment of the present invention.

The ceramic composition according to the exemplary embodiment of the present invention may include a dielectric ceramic powder, an organic binder, and an antistatic agent.

The dielectric ceramic powder is not particularly limited so long as it may be used for a multilayer ceramic capacitor while having a high dielectric constant. Although not limited thereto, for example, a perovskite compound represented by ABO₃, a barium titanate (BaTiO₃)-based material, a strontium titanate (SrTiO₃)-based material, or the like, may be used. In the perovskite-based material, a portion of A-site or B-site may be substituted. In the barium titanate-based material, a portion of Ba may be substituted with Ca or SR and a portion of Ti may be substituted with Zr or Hf. Although not limited thereto, for example, BaTiO₃, BaCaTiO₃, BaTiZrO₃, BaCaTiZrO₃, or the like may be used.

The average particle size of the dielectric ceramic powder may be 0.1 μm to 0.5 μm.

The organic binder is not particularly limited so long as it may be ordinarily used in the art. Although not limited thereto, for example, a cellulose-based resin, a polyvinylbutyral resin, an epoxy resin, an aryl resin, an acrylic resin, a phenol-formaldehyde, an unsaturated polyester resin, a polycarbonate resin, a polyamide resin, a polyimide resin, an alkyd resin, a rosin ester resin, or the like may be used. The cellulose-based resin may be ethyl cellulose.

The content of the organic binder may be 5 to 20 parts by weight per 100 parts by weight of the dielectric ceramic powder.

When the thickness of the dielectric layer is thin, it is difficult to achieve the desired mechanical physical properties. Generally, when the content of the organic binder is increased, the mechanical physical property of the dielectric layers may be achieved. However, when the content of the organic binder is increased, the amount of static electricity generated in the dielectric layers may be increased.

However, in the exemplary embodiment of the present invention, since the antistatic agent is included to thereby reduce the generation of static electricity, a large amount of organic binder may be included, thereby achieving the excellent mechanical physical properties even in the case that the dielectric layer is thin.

In a case that the content of the organic binder is below 5 parts by weight, the mechanical physical properties may be reduced. In a case that the content of the organic binder exceeds 20 parts by weight, the generation of static electricity may be increased or the dielectric characteristics of the ceramic composition may be reduced.

The ceramic composition according to the exemplary embodiment of the present invention includes an antistatic agent represented by the following Chemical Formula:

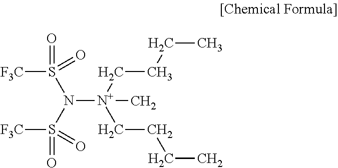

The antistatic agent represented by the above Chemical Formula may be referred to as tri-n-butyl methyl ammonium bis-trifluoromethanesulfonyl imide.

The antistatic agent represented by the above Chemical Formula may absorb static electricity generated on the ceramic dielectric layer. In addition, since the antistatic agent has good compatibility with the dielectric ceramic powder and the organic binder, it can be easily dispersed in the dielectric ceramic composition and does not change the characteristics of the composition.

The content of the antistatic agent represented by the above Chemical Formula may be 0.1 to 10 parts by weight per 100 parts by weight of the dielectric ceramic powder. More preferably, the content of the antistatic agent may be 1 to 5 parts by weight. The antistatic agent in this range of content may not degrade the molding physical properties, dry characteristics, surface roughness, strength, extension, or the like, of the ceramic dielectric layer.

In a case that the content of the antistatic agent is below 0.1 parts by weight, there is a risk of generating static electricity when the dielectric layer is thin. In a case that the content of the antistatic agent exceeds 10 parts by weight, it may be difficult to separate the ceramic green sheet from a carrier film during the stacking process.

The ceramic composition according to the exemplary embodiment of the present invention may use a solvent used in the art. Although not limited thereto, for example, an organic solvent, such as butyl carbitol, butyl carbitol acetate, terpinol, α-terpineol, ethyl cellosolve, butylphthalate, or the like, may be used.

In addition, the ceramic composition according to the exemplary embodiment of the present invention may further include additives such as a plasticizer, a dispersant, or the like.

Although not limited thereto, for example, a phthalate-based plasticizer may be used. In addition, although not limited thereto, for example, a non-ionic phosphate-based dispersant may be used.

The thickness of the dielectric layer, manufactured by comprising the ceramic composition according to the exemplary embodiment of the present invention, may be 10 μM or less. In addition, the thickness thereof in a higher-capacity product may be 2 μm or less and 0.1 μm to 2 μm. In addition, the number of stacked dielectric layers in the multilayer ceramic capacitor may be 100 layers or more.

As the thickness of the dielectric layer is thin, it is difficult to achieve the mechanical physical properties. Therefore, the content of the organic binder is increased, and as the content of the organic binder is increased, the amount of static electricity generated on the ceramic green sheet is increased. In the case that the static electricity is generated on the ceramic green sheet, the ceramic green sheet may be folded during the stacking. In addition, the ceramic green sheet may not be properly separated from the carrier film, or foreign objects may be adsorbed to thereby degrade the quality of the multilayer ceramic capacitor.

However, the ceramic green sheet comprising the ceramic composition according to the exemplary embodiment of the present invention can reduce the generation of static electricity. Even in the case that the thickness of the ceramic green sheet is thin, the generation of static electricity may be reduced and excellent mechanical physical properties may be achieved.

As the generation of static generation is reduced, the peel strength of the ceramic green sheet is degraded and the phenomenon that the ceramic green sheet is folded is prevented, thereby facilitating the stacking of the ceramic green sheets. Further, foreign objects may be prevented from being adsorbed onto the ceramic green sheet during the process. This will be described in more detail in a method of manufacturing a multilayer ceramic capacitor to be described below.

Further, although not shown, the ceramic body may include an adhesive layer formed between the dielectric layers. The adhesive layer may include the organic binder. This organic binder may have a degree of polymerization higher than that of the organic binder used in the ceramic composition.

The inclusion of the adhesive layer may secure excellent inter-layer adhesion between the dielectric layers. This will be described in more detail in a method of manufacturing a multilayer ceramic capacitor to be described below.

Hereinafter, a method of manufacturing a multilayer ceramic capacitor according to an exemplary embodiment of the present invention will be described.

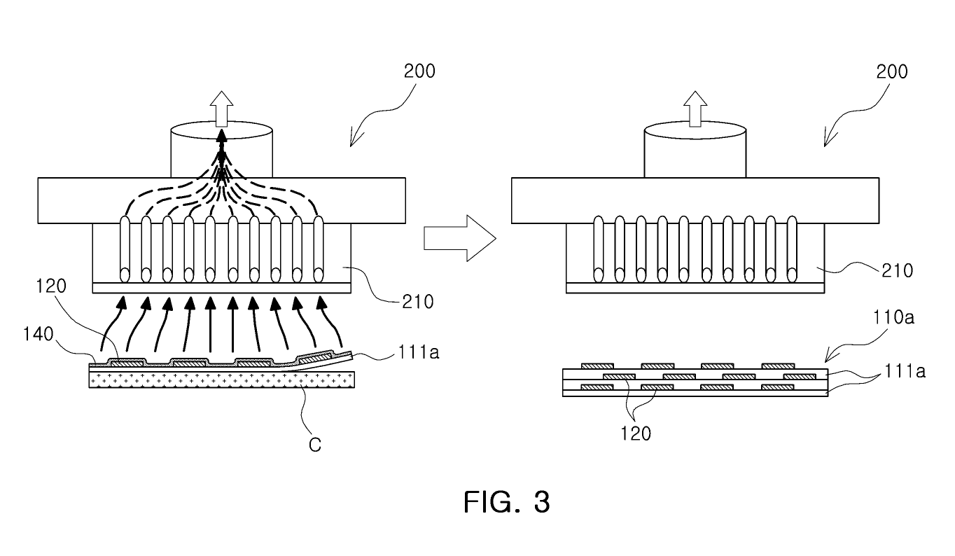

FIG. 3 is a cross-sectional view explaining a method of manufacturing a multilayer ceramic capacitor according to an exemplary embodiment of the present invention.

First, a plurality of dielectric layers are prepared. As described above, the dielectric layers may include the dielectric ceramic composition according to the exemplary embodiment of the present invention. The components and the content thereof in the dielectric ceramic composition according to the exemplary embodiment of the present invention are the same as described above.

A ceramic green sheet comprising the ceramic composition according to the exemplary embodiment of the present invention is manufactured and the dielectric layer may be formed by firing the ceramic green sheet. Hereinafter, this will be described in more detail.

A ceramic slurry may be produced by mixing a dielectric ceramic powder, an organic binder, and an antistatic agent represented by the following Chemical Formula. Here, a solvent used in the art may be used. Although not limited thereto, for example, an organic solvent, such as butyl carbitol, butyl carbitol acetate, terpinol, Q-terpineol, ethyl cellosolve, butylphthalate, or the like, may be used.

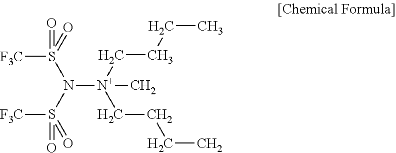

As described above, the antistatic agent represented by the Chemical Formula has good compatibility and dispersibility with the dielectric ceramic powder and the organic binder.

It is difficult for the antistatic agent to move to the surface of the ceramic green sheet, thereby weakening the antistatic effect. Therefore, the antistatic agent may be added to the ceramic slurry in a final process after the mixing of the dielectric ceramic powder and the organic binder.

As described in FIG. 3, a ceramic green sheet 111a having a predetermined thickness may be manufactured by applying the ceramic slurry to a carrier film C and drying it. The ceramic green sheet may be prepared to have a thickness in a range of 10 μm or less.

Next, a conductive paste is applied to the ceramic green sheet 111a, thereby forming an internal electrode pattern 120. The solvent of the conductive paste is not specifically limited. For example, dihydroterpineol (DHTA) may be used therefor.

Thereafter, the ceramic green sheets 111a having the internal electrode pattern 120 formed thereon are stacked in a thickness direction, thereby manufacturing a ceramic laminate 110a.

As shown in FIG. 3, the ceramic green sheets 111a are moved by a laminator, thereby forming the ceramic laminate 110a.

The ceramic green sheet 111a is separated from the carrier film C by a head 210 of the laminator 200. The ceramic green sheet 111a is moved while being adsorbed onto the head 210 and then, is stacked in a thickness direction while being detached from the head 210.

As the ceramic green sheet is easily adsorbed onto the head while being easily separated from the carrier film, the process may be facilitated.

As described above, the ceramic green sheet comprising the ceramic dielectric composition according to the exemplary embodiment of the present invention has a small amount of static elasticity, such that it may be easily separated from the carrier film. That is, the peel strength of the ceramic green sheet may be reduced.

Although not limited thereto, the peel strength of the ceramic green sheet may be 3 to 10 mN/30 mm (2.5 μm sheet).

Further, when the ceramic green sheet is separated from the carrier film or stacked on the laminate, the folding phenomenon of the ceramic green sheet may be prevented. Further, the phenomenon of adsorbing foreign objects into the ceramic green sheet may be prevented.

Further, the adhesive layer 140 may be formed on the ceramic green sheet 111a. The adhesive layer may include the organic binder.

The ceramic green sheet comprising the ceramic composition according to the exemplary embodiment of the present invention has weak static elasticity, such that it may be difficult to be adsorbed onto the head 210 of the laminator 200.

According to the exemplary embodiment of the present invention, when the adhesive layer 140 is formed on the ceramic green sheet 111a, the adhesion between the head 210 of the laminator 200 and the ceramic green sheet 111a may be improved.

The adhesive layer 140 may be formed on the ceramic green sheet 111a by gravure printing.

The organic binder having the degree of polymerization higher than that of the organic binder used in the ceramic green sheet may be used. The adhesive characteristics may be improved according to the use of the organic binder having the higher degree of polymerization.

Further, the organic binder may have good solubility with respect to the solvent used in the conductive paste forming the internal electrodes. For example, the organic binder may be an ethyl cellulose or a polyvinylbutyral resin having good solubility with respect to dihydroterpineol (DHTA).

Further, the solid content of the adhesive layer 140 may be 1 wt % to 20 wt %, preferably, 1 wt % to 7 wt %.

The thickness of the adhesive layer 140 may be selected in consideration of the thickness of the ceramic green sheet, the component and content of the ceramic composition, or the like. Although not limited thereto, for example, the thickness of the adhesive layer 140 may be 150 nm or less, preferably, 50 nm or less.

Thereafter, the ceramic laminate 110a is cut to the chip size to expose one end of the internal electrode pattern 120 to the surface of the ceramic laminate 110a and is fired, thereby forming the ceramic body. The firing is not limited thereto, but may be performed in a N₂-H₂ atmosphere at 1100° C. to 1300° C.

Thereafter, the first and second external electrodes may be formed to be electrically connected to each end of the first and second internal electrode through the ends of the ceramic body, respectively.

Hereinafter, the present invention will be described below in more detail with reference to inventive and comparative examples, but the scope of the present invention is not limited thereto.

1. Measurement of Generation of Static Electricity

A ceramic composition comprising 1 part by weight of an antistatic agent (tri-n-butyl methyl ammonium bis-trifluoromethanesulfonyl imide) per 100 parts by weight of a dielectric ceramic powder was produced. A ceramic green sheet (Inventive Example 1) having a thickness of 0.95 μm and a ceramic green sheet (Inventive Example 2) having a thickness of 0.8 μm were manufactured by using the ceramic composition and the generation of static electricity thereof was measured, which was represented in the following Table 1. Comparative Examples 1 and 2 have the same conditions as those of Inventive Examples 1 and 2, with the exception of the addition of an antistatic agent. That is, a ceramic green sheet (Comparative Example 1) having a thickness of 0.95 μm and a ceramic green sheet (Comparative Example 2) having a thickness of 0.9 μm were manufactured by using a ceramic composition to which an antistatic agent was not added, and the generation of static electricity thereof was measured.

TABLE 1

| | | Inventive | Inventive | Comparative | Comparative |
|---|---|---|---|---|---|
| | | Example 1 | Example 2 | Example 1 | Example 2 |
| Gener- | Measurement | −0.20 | −0.23 | −1.46 | −0.59 |
| ation | 1 | | | | |
| of Static | Measurement | −0.12 | −0.23 | −2.36 | −0.34 |
| Elec- | 2 | | | | |
| tricity | Average | −0.16 | −0.23 | −1.91 | −0.47 |

(Unit: kV)

It could be appreciated from the above Table 1 that Inventive Examples 1 and 2 had a smaller amount of static electricity as compared to Comparative Examples 1 and 2. According to an additional experiment, even after an internal electrode layer was printed on the ceramic green sheet, Inventive Examples 1 and 2 had a small amount of static electricity.

2. Measurement of Peel Strength

The peel strength of the respective ceramic green sheets manufactured according to Inventive Examples 1 and 2 and Comparative Examples 1 and 2 was measured, which was represented in the following Table 2.

TABLE 2

| | | Inventive | Inventive | Comparative | Comparative |
|---|---|---|---|---|---|
| | | Example 1 | Example 2 | Example 1 | Example 2 |
| Peel | Measurement | 5.9 | 6.1 | 12.5 | 10.5 |
| Strength | 1 | | | | |
| | Measurement | 5.7 | 6.9 | 13.3 | 10.1 |
| | 2 | | | | |
| | Measurement | 6.7 | 6.6 | 13.3 | 9.8 |
| | 3 | | | | |
| | Average | 6.1 | 6.5 | 13.0 | 10.1 |

(Unit: mN/30 mm)

It could be appreciated from the above Table 2 that Inventive Examples 1 and 2 had a peel strength lower than that of Comparative Examples 1 and 2.

3. Measurement of Surface Roughness of Ceramic Green Sheet

A ceramic composition including 0.25 parts by weight (Inventive Example 3), 0.625 parts by weight (Inventive Example 4), 1.25 parts by weight (Inventive Example 5), and 2.5 parts by weight (Inventive Example 6) of an antistatic agent (tri-n-butyl methyl ammonium bis-trifluoromethanesulfonyl imide) per 100 parts by weight of a dielectric ceramic powder was individually produced and ceramic green sheets were respectively manufactured by using the individual ceramic compositions. The surface roughness of each of the ceramic green sheets was measured, which was represented in the following Table 3. In addition, the surface roughness of the ceramic green sheet according to Comparative Example 1 was measured, which was represented in the following Table 3.

TABLE 3

| | | Comparative | Inventive | Inventive | Inventive | Inventive |
|---|---|---|---|---|---|---|
| | | Example 1 | Example 3 | Example 4 | Example 5 | Example 6 |
| Surface | Measurement 1 | 0.022 | 0.009 | 0.013 | 0.015 | 0.021 |
| Roughness | Measurement 2 | 0.020 | 0.011 | 0.015 | 0.014 | 0.018 |
| (Ra) | Measurement 3 | 0.017 | 0.013 | 0.014 | 0.014 | 0.017 |
| | Measurement 4 | 0.017 | 0.014 | 0.016 | 0.015 | 0.014 |
| | Measurement 5 | 0.019 | 0.019 | 0.022 | 0.018 | 0.015 |
| | Average | 0.019 | 0.013 | 0.016 | 0.015 | 0.017 |
| Surface | Measurement 1 | 1.86 | 0.41 | 1.63 | 1.87 | 2.17 |
| Roughness | Measurement 2 | 1.91 | 1.63 | 1.73 | 1.40 | 1.80 |
| (Rz) | Measurement 3 | 1.82 | 1.44 | 1.63 | 1.04 | 1.66 |
| | Measurement 4 | 1.80 | 1.23 | 1.59 | 1.53 | 1.61 |
| | Measurement 5 | 1.76 | 1.99 | 1.91 | 1.66 | 1.77 |
| | Average | 1.83 | 1.34 | 1.70 | 1.50 | 1.80 |
| Surface | Measurement 1 | 2.371 | 0.588 | 2.263 | 2.282 | 2.463 |
| Roughness | Measurement 2 | 2.902 | 3.038 | 2.065 | 1.637 | 2.362 |
| (Rt) | Measurement 3 | 2.193 | 1.665 | 2.297 | 1.542 | 2.106 |
| | Measurement 4 | 2.175 | 1.689 | 2.033 | 1.750 | 2.072 |
| | Measurement 5 | 1.983 | 3.006 | 2.345 | 2.008 | 2.172 |
| | Average | 2.325 | 1.997 | 2.201 | 1.844 | 2.235 |

It could be confirmed from the above Table 3 that the surface roughness of each of Inventive Examples 3 to 6 was smaller than that of Comparative Example 1. In view of the fact that protrusions in the green sheet may cause the defects after the stacking, Inventive Examples 3 to 6 showed that a surface roughness value is lowered due to the addition of the antistatic agent.

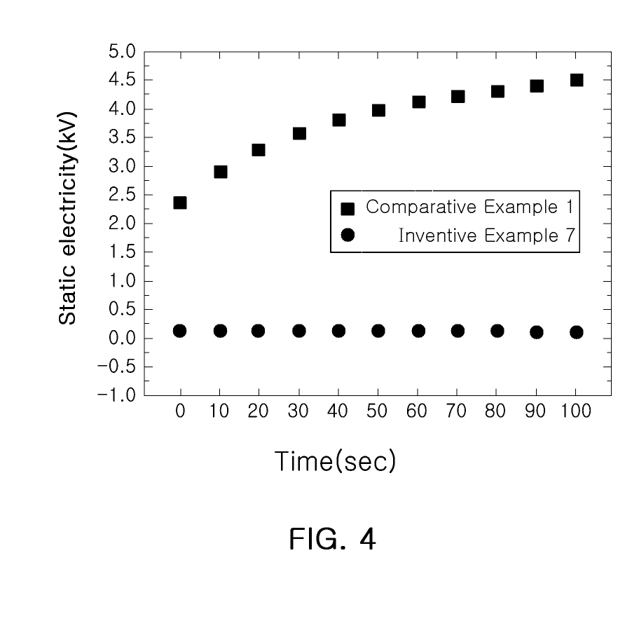

Further, the amount of static electricity generated with the passage of time in a ceramic green sheet (Inventive Example 7) manufactured by using a ceramic composition including 10 parts by weight of an antistatic agent (tri-n-butyl methyl ammonium bis-trifluoromethanesulfonyl imide) per 100 parts by weight of a dielectric ceramic powder and the ceramic green sheet according to Comparative Example 1 was measured. FIG. 4 is a graph showing the amount of static electricity generated over time in the ceramic green sheets according to Inventive Example 7 and Comparative Example 1.

It could be appreciated from FIG. 4 that Inventive Example 7 showed the almost negligible increase in initial electrostatic force even when time passed, while Comparative Example 1 showed a significant increase in electrostatic force with the passage of time.

As set forth above, a ceramic green sheet comprising a ceramic composition according to exemplary embodiments of the present invention may have a small amount of static electricity. Even in the case that the thickness of the ceramic green sheet is thin, the generation of the static electricity is reduced and excellent mechanical physical properties can be achieved.

In addition, as the generation of the static electricity is reduced, the peel strength of the ceramic green sheet can be also reduced and the folding of the ceramic green sheet can be avoided, whereby the stacking of the ceramic green sheets may be facilitated. Further, during the process foreign objects are prevented from being adsorbed onto the ceramic green sheet.

While the present invention has been shown and described in connection with the exemplary embodiments, it will be apparent to those skilled in the art that modifications and variations can be made without departing from the spirit and scope of the invention as defined by the appended claims.

What is claimed is:

1. A ceramic composition for a multilayer ceramic capacitor, the ceramic composition comprising:
a dielectric ceramic powder;
an organic binder; and
an antistatic agent represented by the following Chemical Formula:

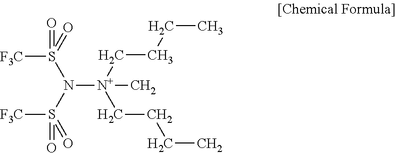

2. The ceramic composition of claim 1, wherein the content of the antistatic agent is 0.1 to 10 parts by weight per 100 parts by weight of the dielectric ceramic powder.

3. The ceramic composition of claim 1, wherein the dielectric ceramic powder is a barium titanate-based material or a strontium titanate-based material.

4. The ceramic composition of claim 1, wherein the content of the organic binder is 5 to 20 parts by weight per 100 parts by weight of the dielectric ceramic powder.

5. A multilayer ceramic capacitor comprising:
a ceramic body having a plurality of dielectric layers stacked therein, the dielectric layers comprising a ceramic composition comprising a dielectric ceramic powder, an organic binder, and an antistatic agent;
internal electrodes formed within the ceramic body; and
external electrodes formed on an outer surface of the ceramic body and electrically connected to the internal electrodes,
wherein the antistatic agent is represented by the following Chemical Formula:

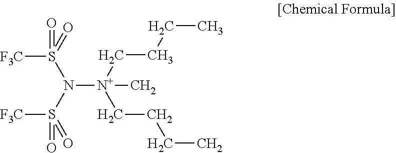

6. The multilayer ceramic capacitor of claim 5, wherein the content of the antistatic agent is 0.1 to 10 parts by weight per 100 parts by weight of the dielectric ceramic powder.

7. The multilayer ceramic capacitor of claim 5, wherein the content of the organic binder is 5 to 20 parts by weight per 100 parts by weight of the dielectric ceramic powder.

8. The multilayer ceramic capacitor of claim 5, wherein the ceramic body further comprises an adhesive layer formed between the plurality of dielectric layers.

9. The multilayer ceramic capacitor of claim 8, wherein the adhesive layer includes an organic binder having a degree of polymerization higher than that of the organic binder of the ceramic composition.

10. The multilayer ceramic capacitor of claim 5, wherein each of the dielectric layers has a thickness of 10 μm or less.

11. The multilayer ceramic capacitor of claim 5, wherein the dielectric layers comprise 100 or more dielectric layers.

12. A method of manufacturing a multilayer ceramic capacitor, the method comprising:
preparing a plurality of ceramic green sheets with a ceramic composition comprising a dielectric ceramic powder, an organic binder, and an antistatic agent;
forming internal electrode patterns on the ceramic green sheets; and
forming a ceramic laminate by stacking the ceramic green sheets in a thickness direction thereof,
wherein the antistatic agent is represented by the following Chemical Formula:

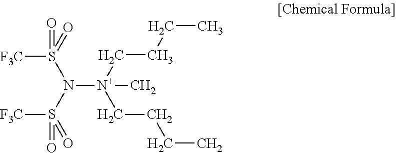

13. The method of claim 12, wherein the forming of the ceramic laminate is performed by adsorbing the ceramic green sheets into a laminator, moving the ceramic green sheets, detaching the ceramic green sheets from the laminator, and stacking the ceramic green sheets in the thickness direction thereof.

14. The method of claim 13, wherein the ceramic green sheets are separated from carrier films and are adsorbed onto the laminator.

15. The method of claim 12, further comprising forming adhesive layers on the ceramic green sheets after the internal electrode patterns are formed on the ceramic green sheets.

16. The method of claim 15, wherein the adhesive layers include an organic binder having a degree of polymerization higher than that of the organic binder of the ceramic composition.

17. The method of claim 12, wherein the content of the antistatic agent is 0.1 to 10 parts by weight per 100 parts by weight of the dielectric ceramic powder.

18. The method of claim 12, wherein the content of the organic binder is 5 to 20 parts by weight per 100 parts by weight of the dielectric ceramic powder.

19. The method of claim 12, wherein each of the ceramic green sheets has a thickness of 10 μm or less.

20. The method of claim 12, wherein the ceramic green sheets comprise 100 or more ceramic green sheets.
